(19) United States
(12) Patent Application Publication
(10) Pub. No.: US 2003/0076311 A1
(43) Pub. Date: Apr. 24, 2003

(54) Computer having a display interface with two basic input/output systems

(75) Inventors: Yao-Nan Lin, Chung-Ho City (TW); Ming-Sheng Lin, Chung-Ho City (TW)

Correspondence Address: LADAS & PARRY, 5670 Wilshire Boulevard, Los Angeles, CA, 90036-5679, US

(73) Assignee: MICRO-STAR INT'L CO., LTD.

(21) Appl. No.: 10/267,428

(22) Filed: Oct. 8, 2002

(30) Foreign Application Priority Data
Oct. 19, 2001 (TW) 090125952

(51) Int. Cl. G09G 5/00

(52) U.S. Cl. 345/204

(57) ABSTRACT

A display interface is adapted for use in a computer to control display of images by a monitor, and includes a first basic input/output system (BIOS) that is capable of being upgraded, a second BIOS that is maintained in an original version, and a switch unit associated operably with the first and second BIOS and capable of switching from a first state, where the first BIOS is selected for use when the computer is activated, and a second state, where the second BIOS is selected for use when the computer is activated.

### CROSS-REFERENCE TO RELATED APPLICATION

This application claims priority of Taiwanese Application No. 090125952, filed on Oct. 19, 2001.

### BACKGROUND OF THE INVENTION

1. Field of the Invention

The invention relates to a computer display interface, more particularly to a computer display interface that incorporates two basic input/output systems (BIOS).

2. Description of the Related Art

A conventional display card is generally in the form of a circuit board that is installed in a computer for controlling image display by a monitor. Some of the functions of the conventional display card include three-dimensional image processing and accelerated graphics processing. A conventional display card has a BIOS memory with a basic input/output system (BIOS) resident therein. The BIOS of the conventional display card is loaded into a random access memory on a motherboard of the computer when the computer is turned on for executing a power-on self-test (POST) operation of the display system. The monitor will display information from the computer, and the computer will proceed with operations, such as testing of other electrical devices of the computer, when the POST operation of the display system has been successfully concluded. Accordingly, when an error occurs during the POST operation of the display system, driving of the monitor for image display will not be possible.

With the ongoing progress in the computer industry, it is not uncommon for manufacturers to periodically release upgraded versions of BIOS. Since the BIOS of the conventional display card resides in a BIOS memory, such as a flash memory device or an electrically erasable programmable read-only memory (EEPROM), the computer user can upgrade the BIOS through software control without the need for conducting replacement of the BIOS memory.

FIG. 1 illustrates a conventional method for upgrading the BIOS of a display card. As shown, after a computer is turned on at step 11, the computer loads a disk operating system (DOS) at step 12. Thereafter, at step 13, a disk containing the upgraded BIOS is inserted into a disk drive. Next, at step 14, an upgrade command is inputted to clear the original BIOS stored in the BIOS memory of the display card, and to store the upgraded BIOS in the BIOS memory. Finally, at step 15, the computer is restarted to load the upgraded BIOS into the motherboard of the computer for executing the associated POST operation.

FIG. 2 illustrates another conventional method for upgrading the BIOS of a display card. Unlike the method of FIG. 1, the upgraded BIOS file is posted by the manufacturer on a website and is available for downloading by the computer user. As shown, after a computer is turned on at step 21, the computer loads a windows operating system at step 22. Thereafter, on-line upgrading of the BIOS is performed at step 23, wherein, when the computer is linked to the manufacturer's website, the upgraded BIOS file is downloaded and stored in a hard disk of the computer. The original BIOS stored in the display card is then cleared, and the upgraded BIOS file in the hard disk is subsequently stored in the display card. Finally, at step 24, the computer is restarted to load the upgraded BIOS into the computer.

However, it is noted that flash fail errors, which can lead to inability of the monitor to display images due to failure of the computer to load the correct BIOS of the display card when the computer is turned on, can occur during upgrading of the BIOS using either of the aforesaid methods. Particularly, when power failure occurs during execution of step 14 of the method of FIG. 1 or step 23 of the method of FIG. 2, BIOS data of the display card will be lost, corrupted or incompletely recorded. Moreover, in the method of FIG. 2, due to the multi-tasking capability of windows operating systems, interruption of the data clearing and writing operations of step 23, such as due to execution of a screen saver routine, can also lead to loss, corruption and incomplete recording of BIOS data. Furthermore, in the method of FIG. 2, data loss can occur during the downloading of the upgraded BIOS file over the Internet.

When the BIOS of the display card contains flash errors, normal activation of the display card is not possible, and the monitor will not be able to display images thereon. Under such a situation, the display card has to be returned to the manufacturer for replacing the BIOS memory, thereby resulting in inconvenience and additional expenses to both the computer user and the manufacturer.

### SUMMARY OF THE INVENTION

Therefore, the main object of the present invention is to provide a computer display interface that incorporates a first BIOS which can be upgraded and a second BIOS which is maintained in an original version so that, when flash fail errors are detected in the first BIOS after the first BIOS is upgraded, the second BIOS can be selected for use during subsequent activation of a computer, thereby eliminating the need to return the computer display interface to the manufacturer for repair as commonly encountered in the prior art.

Another object of the present invention is to provide a computer that incorporates the display interface of this invention.

According to one aspect of the invention, a display interface is adapted for use in a computer to control display of images by a monitor, and comprises:

a first basic input/output system (BIOS) capable of being upgraded;

a second BIOS maintained in an original version; and

a switch unit associated operably with the first and second BIOS and capable of switching from a first state, where the first BIOS is selected for use when the computer is activated, and a second state, where the second BIOS is selected for use when the computer is activated.

According to another aspect of the invention, a computer comprises a motherboard, a monitor, and a display interface coupled to the motherboard and the monitor and enabling the monitor to display images thereon. The display interface includes:

a first basic input/output system (BIOS) capable of being upgraded;

a second BIOS maintained in an original version; and

a switch unit coupled to the motherboard, associated operably with the first and second BIOS, and capable of switching from a first state, where the first BIOS is selected for use by the motherboard when the computer is activated, and a second state, where the second BIOS is selected for use by the motherboard when the computer is activated.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart illustrating a conventional method for upgrading the BIOS of a display card;

FIG. 2 is a flowchart illustrating another conventional method for upgrading the BIOS of a display card;

FIG. 3 is a schematic circuit block diagram illustrating the preferred embodiment of a computer with a display interface according to the present invention;

FIG. 4 illustrates a switch unit of the preferred embodiment;

FIG. 5 is a flowchart to illustrate a computer-activating operation of the preferred embodiment; and

FIG. 6 is a flowchart to illustrate a BIOS-upgrading operation of the preferred embodiment.

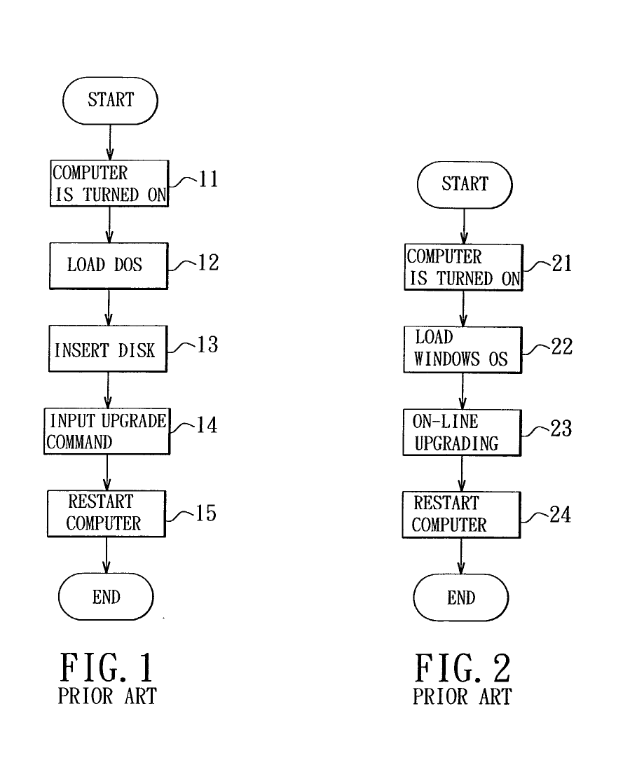

### DETAILED DESCRIPTION OF THE PREFERRED EMBODIMENT

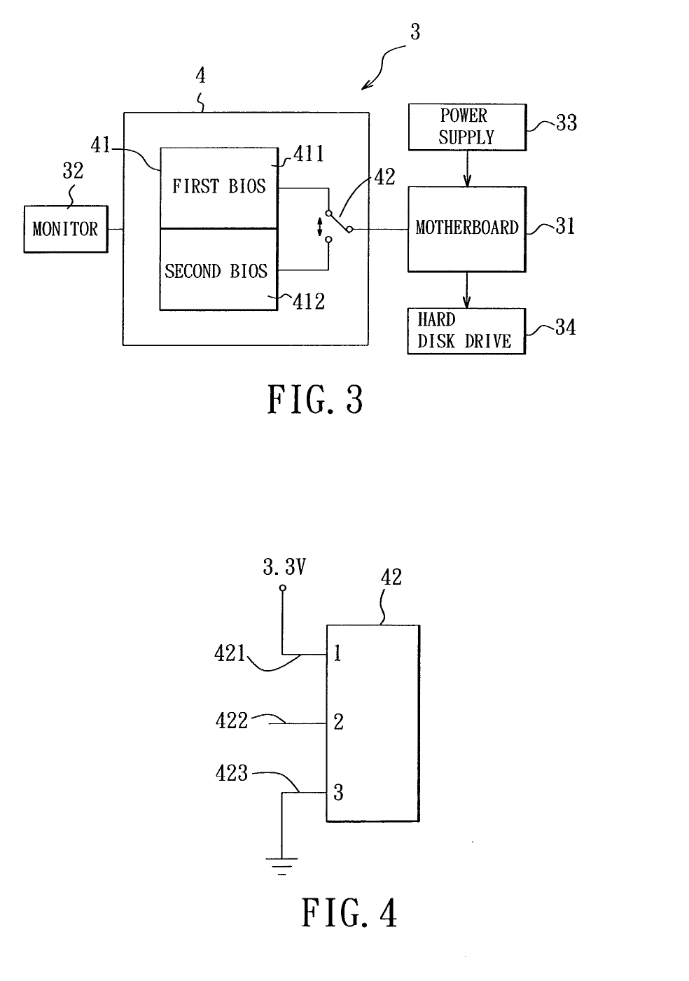

Referring to FIG. 3, the preferred embodiment of a computer 3 according to this invention is shown to include a display interface 4 that is coupled to a motherboard 31 and a monitor 32 and that controls display of images by the monitor 32. The computer 3 may be a personal computer, a workstation, a minicomputer, a supercomputer, etc. The display interface 4 may be in the form of an interface card that is adapted to be mounted on the motherboard 31, or a circuit cluster that is integrated with the motherboard 31. As is known in the art, the motherboard 31 is the connecting and transmitting medium between the computer 3 and peripheral devices (not shown), and includes a microprocessor, memory devices, etc. While the computer 3 is shown in FIG. 3 to include the motherboard 31, the monitor 32, a power supply 33 and a hard disk drive 34, it is apparent to those skilled in the art that the computer 3 actually includes other electronic devices, such as a sound card, a floppy disk drive, a computer mouse, etc., which are not illustrated for the sake of brevity. The display interface 4 includes a first basic input/output system (BIOS) 411, a second BIOS 412, and a switch unit 42.

In the present invention, data of the first BIOS 411 can be modified to upgrade the version of the first BIOS 411. On the other hand, the second BIOS 412 is maintained in its original version. Thus, when the display interface 4 is purchased by the computer user, the contents of the first and second BIOS 411, 412 are identical. Further, when conducting BIOS upgrade, only the data of the first BIOS 411 will be modified such that the data of the first BIOS 411 will eventually differ from that of the second BIOS 412. Preferably, each of the first and second BIOS 411, 412 resides in a programmable memory 41, such as a flash read-only memory or an electrically erasable programmable read-only memory (EEPROM). In this embodiment, the memory size of the programmable memory 41 is about 1 Megabit, which is sufficient to contain two BIOS files, each typically being about 64 Kilobytes in size. Thus, the first and second BIOS 411, 412 can simultaneously reside in a single programmable memory 41 to reduce the space occupied thereby on a circuit board. Since procedures for upgrading the first BIOS 411 are known in the art, such as the conventional methods described beforehand, a detailed description of the same will be dispensed with herein for the sake of brevity.

The switch unit 42 is capable of switching between first and second states. When the switch unit 42 is in the first state, the first BIOS 411 will be selected during activation of the computer 3 for performing power-on self-test (POST) operation of the display system. On the other hand, when the switch unit 42 is in the second state, the second BIOS 412 will be selected during activation of the computer 3 for performing POST operation of the display system. With further reference to FIG. 4, in this embodiment, the switch unit 42 is a manually operable jumper switch having first, second and third terminals 421, 422, 423. The first terminal 421 is tied to a high logic state, such as 3.3-volt power source. The second terminal 422 is coupled to a most significant address bit of the programmable memory 41. The third terminal 423 is grounded. When the switch unit 42 is in the first state, the second terminal 422 is tied to the high logic state, and the part of the programmable memory 41 that contains the first BIOS 411 will be selected for use during activation of the computer 3. Accordingly, when the switch unit 42 is in the second state, the second terminal 422 is tied to the low logic state, and the part of the programmable memory 41 that contains the second BIOS 412 will be selected for use during activation of the computer 3. Preferably, the switch unit 42 is initially set to the first state.

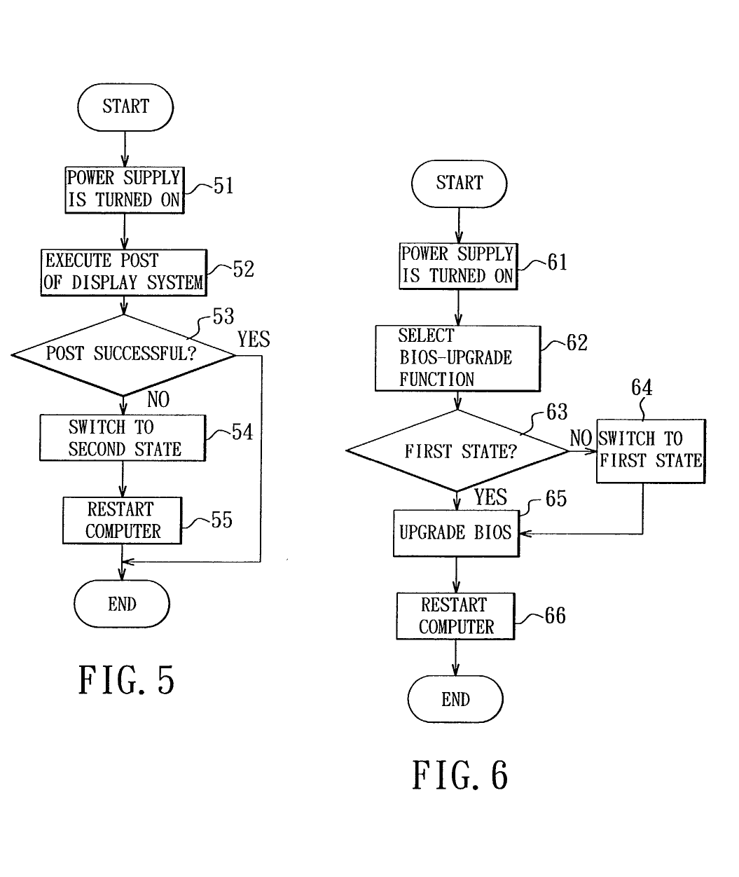

FIG. 5 illustrates a computer-activating operation of the preferred embodiment. Initially, after the power supply 33 of the computer 3 is turned on at step 51, the computer 3 will start performing POST operations for the various system components under the control of system BIOS at step 52. During this time, the first BIOS 411 of the display interface 4 will be loaded into the motherboard 31 of the computer 3 to perform the POST operation associated with the display interface 4. Thereafter, at step 53, it is determined if the POST operation of the display system was successful. In the affirmative, the remaining POST operations associated with the system BIOS of the motherboard 31 will be executed by the computer 3 accordingly. On the other hand, when the POST operation for the display system is unsuccessful, the monitor 32 will be unable to display images thereon. The computer user is thus informed of the presence of flash fail errors in the first BIOS 411, and at step 54, the computer user operates the switch unit 42 to switch from the first state to the second state. Then, at step 55, the computer 3 is restarted so that the POST operation of the display system will be subsequently executed with reference to the second BIOS 412. Because the second BIOS 412 is maintained in its original version, it does not include flash fail errors that may be present in the first BIOS 411 when the latter is upgraded. Thus, the POST operation of the display system will proceed successfully when executed with reference to the second BIOS 412, and the situation that the monitor 32 will be unable to display images thereon can be avoided.

FIG. 6 illustrates a BIOS-upgrading operation of the preferred embodiment. Initially, at step 61, the computer 3 is turned on and loads an operating system. Then, at step 62, under the platform of the operating system, the function of upgrading BIOS software is selected. At step 63, it is detected if the switch unit 42 is in the first state. If no, step 64 is performed to change the state of the switch unit 42 from the second state to the first state, thereby ensuring that the second BIOS 412 will be maintained in its original version. If the switch unit 42 is already in the first state, the flow proceeds to step 65, where the first BIOS 411 is upgraded in a conventional manner. Finally, the computer 3 is restarted at step 66.

Due to the presence of the second BIOS 412, which is maintained in its original version and which can be selected through the switch unit 42, activation of the display interface 4 can be ensured even if the first BIOS 411 contains flash fail errors when the latter is upgraded, thereby eliminating the need to return the display interface 4 to the manufacturer for repair as commonly encountered in the prior art. Moreover, by virtue of the second BIOS 412, upgrading of the first BIOS 411 can be repeated by the computer user upon detecting that the first BIOS 411 contains flash fail errors. In view of the fact that the cost of the 1-Megabit programmable memory 41 approximates that of a 512-Kilobit memory, the use of the single programmable memory 41 and the switch unit 42 does not result in a significant increase in both manufacturing costs and circuit board layout overhead.

It should be apparent to those skilled in the art that the first and second BIOS 411, 412 can be stored in separate programmable memories during actual implementation of the display interface 4 of this invention. Moreover, instead of using a manually operable jumper switch, the switch unit 42 may be alternatively designed to be in the form of a known switch having an automatic switching capability.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A display interface adapted for use in a computer to control display of images by a monitor, said display interface comprising:
a first basic input/output system (BIOS) capable of being upgraded;
a second BIOS maintained in an original version; and
a switch unit associated operably with said first and second BIOS and capable of switching from a first state, where said first BIOS is selected for use when the computer is activated, and a second state, where said second BIOS is selected for use when the computer is activated.

2. The display interface as claimed in claim 1, wherein said switch unit is switched from the first state to the second state when the monitor fails to display images thereon due to presence of flash fail errors in said first BIOS after said first BIOS is upgraded.

3. The display interface as claimed in claim 1, wherein said switch unit is switched to the first state when upgrading of said first BIOS is to be performed.

4. The display interface as claimed in claim 1, wherein at least one of said first and second BIOS resides in a programmable memory.

5. The display interface as claimed in claim 1, wherein said first and second BIOS reside in a single programmable memory.

6. The display interface as claimed in claim 5, wherein said switch unit is a manually operable jumper switch having a first terminal tied to a high logic state, a second terminal coupled to a most significant address bit of said programmable memory, and a third terminal tied to a low logic state, said second terminal being tied to one of the high and low logic states when switched to a respective one of the first and second states.

7. The display interface as claimed in claim 1, wherein said switch unit is a manually operable switch.

8. A computer comprising a motherboard, a monitor, and a display interface coupled to said motherboard and said monitor and enabling said monitor to display images thereon, said display interface including:
a first basic input/output system (BIOS) capable of being upgraded;
a second BIOS maintained in an original version; and
a switch unit coupled to said motherboard, associated operably with said first and second BIOS, and capable of switching from a first state, where said first BIOS is selected for use by said motherboard when the computer is activated, and a second state, where said second BIOS is selected for use by said motherboard when the computer is activated.

9. The computer as claimed in claim 8, wherein said switch unit is switched from the first state to the second state when said monitor fails to display images thereon due to presence of flash fail errors in said first BIOS after said first BIOS is upgraded.

10. The computer as claimed in claim 8, wherein said switch unit is switched to the first state when upgrading of said first BIOS is to be performed.

11. The computer as claimed in claim 8, wherein at least one of said first and second BIOS resides in a programmable memory.

12. The computer as claimed in claim 8, wherein said first and second BIOS reside in a single programmable memory.

13. The computer as claimed in claim 12, wherein said switch unit is a manually operable jumper switch having a first terminal tied to a high logic state, a second terminal coupled to a most significant address bit of said programmable memory, and a third terminal tied to a low logic state, said second terminal being tied to one of the high and low logic states when switched to a respective one of the first and second states.

14. The computer as claimed in claim 8, wherein said switch unit is a manually operable switch.
